(19) United States
(12) Patent Application Publication
(10) Pub. No.: US 2024/0406270 A1
(43) Pub. Date: Dec. 5, 2024

(54) PROVIDING INTEGRATION FLOWS BETWEEN ENDPOINT SYSTEMS

(71) Applicant: International Business Machines Corporation, Armonk, NY (US)

(72) Inventors: John Anthony Reeve, Winchester (GB); Chengxuan Xing, Winchester (GB); Benjamin Graham Thompson, Eastleigh (GB); John Hosie, Eastleigh (GB)

(21) Appl. No.: 18/447,475

(22) Filed: Aug. 10, 2023

(30) Foreign Application Priority Data
Jun. 2, 2023 (GB) 2308258.9

(51) Int. Cl. H04L 67/141; H04L 67/10

(52) U.S. Cl. CPC H04L 67/141; H04L 67/10

(57) ABSTRACT

A method, computer program product, and computer system are described for providing integration flows between endpoint systems. The method includes providing a delegation integration module for each of multiple disparate types of endpoint systems, wherein a delegation integration module for a type of endpoint system is configured to understand how to construct and coordinate integration artifacts in the endpoint system type. The method includes defining an integration flow with required endpoint systems. This integration flow includes generating required linked integration artifacts, injecting the integration artifacts into the relevant endpoint systems that are ready for execution, delegating integration tasks of the integration flow via the delegation integration modules to the required endpoint systems, and using the linked integration artifacts at the endpoint systems to carry out the integration tasks.

### BACKGROUND

The present invention relates to providing integration flows, and more specifically, to providing integration flows between endpoint systems.

An integration platform, such as an enterprise service bus, supplies a communication system between mutually interacting applications and services in a service-oriented architecture. An integration platform provides capabilities to build integration flows needed to support diverse integration requirements through a set of connectors to a range of endpoint data sources, including packaged applications, files, mobile devices, messaging systems, and databases.

The conventional approach taken by integration tools involves a developer designing, developing, and deploying integration flows using an integration application design tool in the integration platform.

When integrating two or more systems, conventionally an integration component in the form of an integration runtime engine is introduced which hosts the integration. This integration component adds complexity, system administration costs, and an additional point of failure. Also, the integration logic is stored outside the end systems, making it not obvious when two piece of integration logic introduce conflicts.

Cloud-based integration provides a system integration delivered as a cloud computing service with the integration platform deployed as a multi-tenant, elastic cloud infrastructure. However, this still requires a cloud-based server for the integration flows with associated costs and system administration.

### SUMMARY

According to an embodiment of the present invention there is provided a computer-implemented method for providing integration flows between endpoint systems, said method comprising a method carried out at a client integration tool of: providing a delegation integration module for each of multiple disparate types of endpoint systems, wherein a delegation integration module for a type of endpoint system is configured to understand how to construct and coordinate integration artifacts in the endpoint system type; defining an integration flow with required endpoint systems including generating required linked integration artifacts and injecting the integration artifacts into the relevant endpoint systems ready for execution; and delegating integration tasks of the integration flow via the delegation integration modules to the required endpoint systems to use the linked integration artifacts at the endpoint systems to carry out the tasks.

The method provides the advantage of delegating integration tasks of an integration flow to endpoint systems avoiding the need for an integration runtime engine. Endpoint systems may have disparate protocols and the method provides a delegation integration module for a type of endpoint system configured to understand how to construct and coordinate integration artifacts in the endpoint system type. The method and system delegate integration steps or tasks to the endpoint systems through injecting integration artifacts into the endpoint systems and linking these logically and physically to provide the integration flow.

The linked integration artifacts may include annotations configured to gather and correlate logs and metrics from the endpoint systems involved in an integration flow. The endpoint systems may run an integration flow with the delegated integration tasks and may gather and correlate logs and metrics from the integration flow using the annotations. This has the advantage of monitoring the integration flow that are run on the endpoint systems.

According to another embodiment of the present invention there is provided system for providing integration flows between endpoint systems, the system comprising: a processor and a memory configured to provide computer program instructions to the processor to execute the function of the components; a client integration tool including: a delegation integration module for each of multiple disparate types of endpoint systems, wherein a delegation integration module for a type of endpoint system is configured to understand how to construct and coordinate integration artifacts in the endpoint system type; and a flow editor component for defining an integration flow with required endpoint systems including generating required linked integration artifacts and injecting the integration artifacts into the relevant endpoint systems ready for execution and delegating integration tasks of the integration flow via the delegation integration modules to the required endpoint systems to use the linked integration artifacts at the endpoint systems to carry out the tasks.

According to a further embodiment of the present invention there is provided computer program product for providing integration flows between endpoint systems and provided as a client integration tool, the computer program product comprising a computer readable storage medium having program instructions embodied therewith, the program instructions executable by a processor to cause the processor to: provide a delegation integration module for each of multiple disparate types of endpoint systems, wherein a delegation integration module for a type of endpoint system is configured to understand how to construct and coordinate integration artifacts in the endpoint system type; define an integration flow with required endpoint systems including generating required linked integration artifacts and injecting the integration artifacts into the relevant endpoint systems ready for execution; and delegate integration tasks of the integration flow via the delegation integration modules to the required endpoint systems to use the linked integration artifacts at the endpoint systems to carry out the tasks.

The computer readable storage medium may be a non-transitory computer readable storage medium and the computer readable program code may be executable by a processing circuit.

According to an aspect of the present invention, there is a method, computer program product and/or system for providing integration flows between endpoint systems having various types of a plurality of endpoint types that performs the following operations (not necessarily in the following order): (i) for each given endpoint type, receiving a delegation integration module designed to be used to handle integration flows for the given endpoint type, with each delegation integration module being configured to construct and coordinate integration artifacts in endpoint systems of the given endpoint type; (ii) receiving a request to perform a first integration flow between a first set of endpoint systems characterized by a first endpoint type of the plurality of endpoint types; and (iii) responsive to the request, performing the first integration flow between the first set of endpoint systems using a first delegation integration module designed for the first endpoint type, with the performance of the first integration flow including: (a) generating a plurality of linked integration artifacts and injecting the plurality of linked integration artifacts into the first set endpoint systems, and (b) delegating integration tasks of the first integration flow, by the first delegation integration module, to the first set endpoint systems to use the linked integration artifacts at the endpoint systems to carry out a plurality of tasks of the first integration flow.

### BRIEF DESCRIPTION OF THE DRAWINGS

FIG. 1 is a flow diagram of an example embodiment of an aspect of a method in accordance with embodiments of the present invention;

FIG. 2 is a flow diagram of an example embodiment of another aspect of a method in accordance with embodiments of the present invention;

FIG. 3 is a flow diagram of an example embodiment of a further aspect of a method in accordance with embodiments of the present invention;

FIG. 4 is a block diagram of an example embodiment of a system in accordance with embodiments of the present invention;

FIG. 5 is a block diagram of an example embodiment of a client system in accordance with embodiments of the present invention; and

FIG. 6 is a block diagram of an example embodiment of a computing environment for the execution of at least some of the computer code involved in performing the present invention.

### DETAILED DESCRIPTION

Embodiments of a method, system, and computer program product are disclosed for providing integration flows between disparate endpoint systems by delegating the integration tasks of an integration flow to the endpoint systems.

A method and a system are provided to deploy and manage an integration solution without the need for an additional integration runtime engine. A serverless integration system and method are disclosed that build, deploy, run, and monitor logical integration flows between multiple disparate endpoint systems which communicate across disparate protocols. The method and system delegate integration steps or tasks to the endpoint systems through injecting integration artifacts into the endpoint systems and linking these logically and physically to provide the integration flow.

A client integration tool is utilized to discover data objects from the endpoint systems, model the relationships between the endpoint systems including transformation logic and data mappings, generate the required integration code and configuration artifacts, and inject the artifacts into the relevant endpoint systems ready for execution. Annotations may be included in the injected integration artifacts to enable the gathering and correlation of logs and metrics from the running delegated integration flows.

The serverless integration system is an improvement in the technical field of integration flows in cloud environments with disparate endpoint systems. More particularly, serverless integration system is provided in the technical field of decentralization of the running integration flows. This provides the technical contribution of removing the need to have an integration server. Through the delegation of the tasks of running integration flows in endpoint systems, the user avoids the running costs, maintenance costs and system administration costs of running a separate intermediate integration engine or service bus between endpoint systems.

By gathering logs and metrics from all the running integration flows which have been delegated (identified via annotations set on the integration artifacts) separately to different endpoint systems, the user benefits from a holistic overview of the results of all the intermediate steps in the logical end to end integration process.

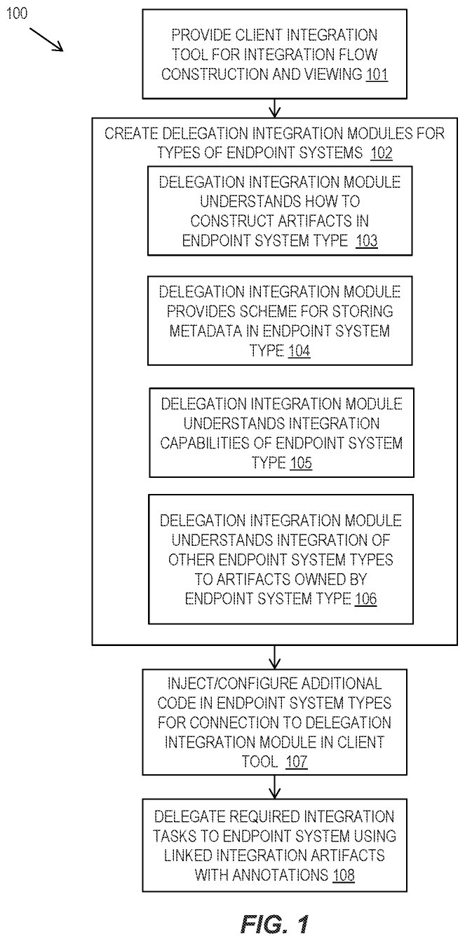

With reference to FIG. 1, a flow diagram 100 shows an example embodiment of an aspect of the method for providing integration flows between disparate endpoint systems. In this aspect, the method provides the modules for delegating the integration flow functionality to the endpoint systems.

The method provides 101 a client integration tool for integration flow construction and viewing at a client computing system. The client integration tool delegates the integration logic out to the endpoint systems and is not needed after the delegation has occurred. The client integration tool constructs everything required for the integration flows to work in the endpoint systems and adds annotations or labels to store metadata about how these have been set up. The client integration tool may then be turned off while the integration flow is left running in the endpoint systems. The client integration tool can be started back up when the integration flow logic needs to be changed. When the client integration tool starts up, it uses the labels and annotations to identify the integration flow delegated functions. The client integration tool does not need a separate store of any other information.

The client integration tool provides 102 delegation integration modules for types of endpoint systems. A delegation integration module is provided for each of multiple disparate types of endpoint systems and is configured to understand how to construct and coordinate integration artifacts in the endpoint system type.

The delegation integration modules may be created for types of endpoint systems. Endpoint system may be any system that provides applications or services that may be configured as part of an integration. Endpoint system may be cloud-based systems, remote server-based systems, or on premise server-based systems. The endpoint systems may include integration products themselves, however these are not essential and may be added as endpoint systems where their functionality is required as the other endpoint systems do not have the required functionality.

As an ongoing example used in the description to illustrate the method and system, the endpoint systems may be enterprise resource planning system (for example, SAP (Systems Applications and Products in Data Processing) system (SAP is a trademark of SAP SE)) and customer relationship management system (for example, Salesforce system (Salesforce is a trademark of Salesforce, Inc.)). The endpoint systems may include integration products themselves, however these are not essential for the overall system to function. Examples of integration endpoint systems may include MuleSoft (MuleSoft is a trademark of MuleSoft, LLC.) and IBM App Connect Enterprise (IBM is a trademark of International Business Machines Corporation).

The delegation integration module for a type of endpoint system understands 103 how to construct artifacts in the endpoint system type. The integration artifacts may be code artifacts and configuration artifacts and may define an integration flow's behavior and functionalities. As examples, integration flow artifacts may include REST (Representational state transfer), SOAP (Simple Object Access Protocol), and OData (Open Data Protocol) Application Programming Interfaces (APIs).

The delegation integration module for a type of endpoint system provides 104 a scheme for storing metadata in that endpoint system to show which components configured there are part of which logical integration flow.

The delegation integration module for a type of endpoint system understands 105 the capabilities of within that endpoint system. For example, the delegation integration modules for an enterprise resource planning system endpoint system would need to understand if the enterprise resource planning system has the function to call the customer relationship management system endpoint system directly and hence a flow to integrate the two could be done just using the enterprise resource planning system and the customer relationship management system delegation integration modules.

The delegation integration module for a type of endpoint system understands 106 which instance of other endpoint systems were integrated in the artifacts the endpoint system owns. For example, if the enterprise resource planning system has an integration to call a specific customer relationship management system service instance, it needs to provide the customer relationship management system service instance identifier so that it can be used to discover and chain other integrations in that specific customer relationship management system instance.

Additional code may be injected or configured 107 in the endpoint system types to enable connection with a delegation integration module at the client integration tool. This additional code is referred to as injected integration modules. These injected integration modules are optional as it may be possible to set up the connection with the endpoint system purely using external interfaces of the endpoint system.

Using the delegation integration modules for types of endpoint systems, logical integration flows may be provided between multiple endpoint systems by delegating 108 integration tasks of an integration flow to endpoint systems through injecting linked integration artifacts. The linked integration artifacts may include annotations configured to gather and correlate logs and metrics from a running delegated integration flow.

There are two main ways in which artifacts may be linked: by a logical link or by a physical link. Artifacts may be logically linked in the sense that they make up part of the same integration flow. Annotations, labels, comments, and/or metadata in the system may be used to do this logical linking. A link may be that artifacts have the name of the integration flow they are part of and they know who calls the other to provide the ordering of the artifact's execution. Artifacts may be physically linked where a deployed artifact has a mechanism to call the other mechanism using capabilities of the system. For example, this linking may use REST API calls between systems, messaging calls between systems, or web hooks.

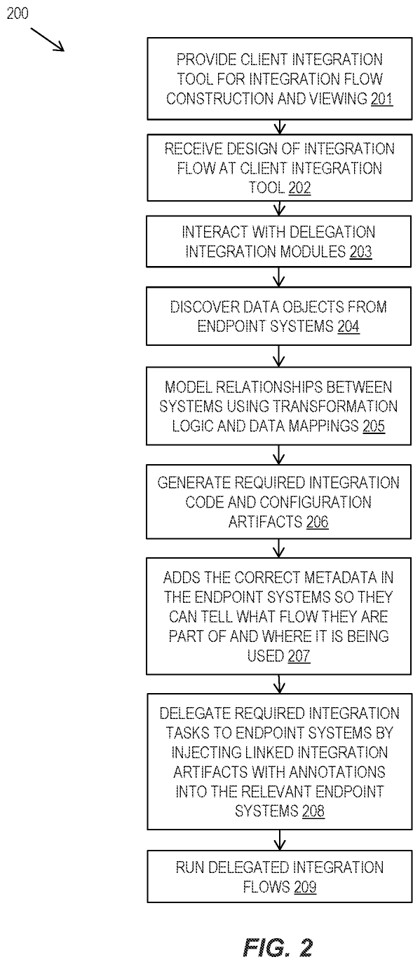

Referring to FIG. 2, a flow diagram 200 shows an example embodiment of a method carried out at the client integration tool when building an integration flow using one or more endpoint system.

The method may provide 201 the client integration tool for integration flow construction and viewing by a user. The method may receive 202 a design of an integration flow at client integration tool.

The method may interact 203 with the delegation integration modules of the required endpoint systems. The method may discover 204 data objects from the endpoint systems. The method may model 205 relationships between endpoint systems using transformation logic and data mappings.

The method may generate 206 the required integration code and configuration artifacts. Each delegation integration module may add 207 the correct metadata in the endpoint system when creating the integration so that is can tell what flow it is part of and where it is being used.

The method may delegate 208 the required integration tasks to the endpoint systems by injecting the artifacts into the relevant endpoint systems ready for execution. The artifacts may include annotations to enable the gathering and correlation of logs and metrics from the running delegated integration flows.

The method may run 209 the delegated integration flow at which time the client integration tool is not involved in the running of the integration flow. The client integration tool may be turned off while the integration flow is running in the endpoint systems. The client integration tool can be started back up if or when the integration flow logic needs to be changed. When the client integration tool starts up it uses the labels and annotations to identify the integration flow delegated functions.

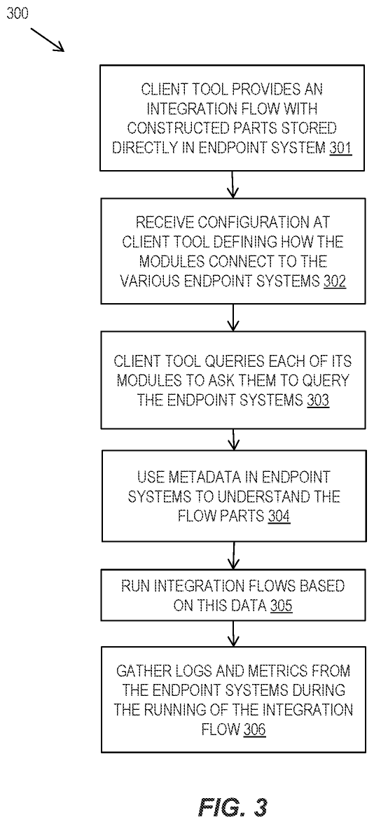

Referring to FIG. 3, a flow diagram 300 shows an example embodiment of a method carried out when running an integration flow using one or more endpoint systems.

The client integration tool may provide 301 an integration flow with constructed parts stored directly in endpoint systems.

The method may receive 302 configurations at the client integration tool defining how the modules connect to the various endpoint systems.

The method may query 303 each of the delegation integration modules to ask them to query the endpoint systems. The method may use 304 the metadata in the endpoint systems to understand the flow parts and their interaction. The integration flow is run 305 based on this data.

The method gathers 306 the logs and metrics from the linked artifacts in the endpoint systems involved in the integration flow.

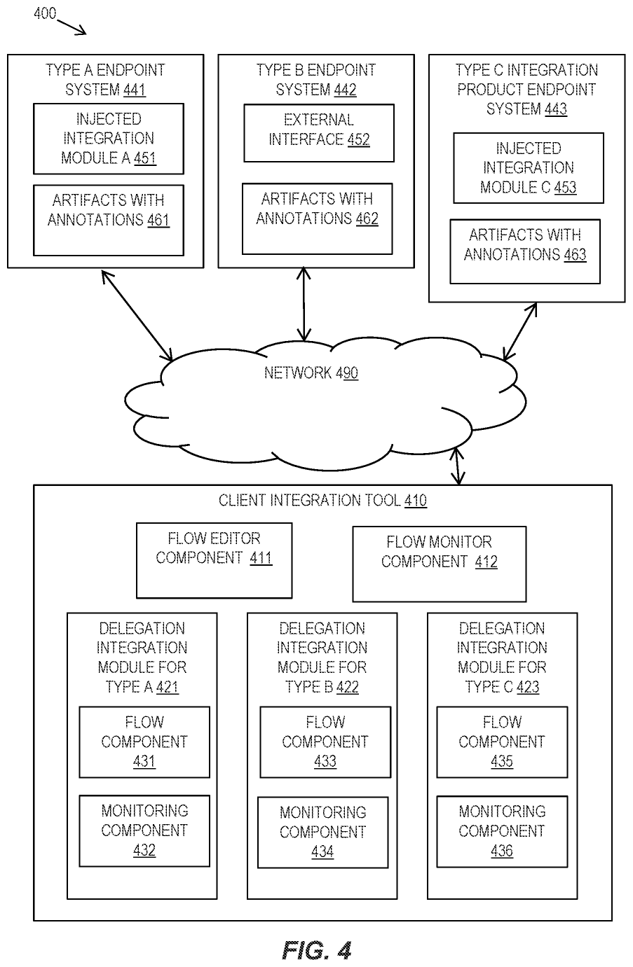

FIG. 4 shows an example embodiment of a system 400 for providing integration flows between disparate endpoint systems 441-443 connected via a computer network 490. A client integration tool 410 is described that provides a delegation integration module 421-423 for each of multiple disparate types of endpoint systems 441-443. A delegation integration module 421-423 for a type of endpoint system 441-443 is configured to understand how to construct and coordinate integration artifacts 461-463 in the endpoint system type 441-443. The artifacts 461-463 may include annotations configured to gather and correlate logs and metrics from the endpoint systems involved in an integration flow.

The client integration tool 410 provides the ability for an integration developer to construct and view integrations. The client integration tool 410 retrieves all information about integration flows from a combination of information stored in all the endpoint systems 441-443 that provide applications or services which the client integration tool 410 connects to via the use of its delegation integration module 421-423. Unlike traditional integration engines, the client integration tool 410 does not rely on any central integration server for either constructing or running integrations.

Endpoint systems 441-443 may be any system that provides applications or services that may be configured as part of an integration and may be cloud-based systems, remote server-based systems, or on premise server-based systems. Some types of endpoint systems (type A, type B) 441, 442 may be a non-integration service providing system. Other types of endpoint systems (type C) 443 may be integration products themselves, however these are not essential and may be added as endpoint systems where their functionality is required as the other endpoint systems 441, 442 do not have the required functionality.

The non-integration endpoint systems 441, 442 may be, as examples, an enterprise resource planning system and a customer relationship management system for customer relationship management. Other examples of non-integration endpoint systems may be an endpoint system for marketing automation or an endpoint system for instant messaging. The integration endpoint systems may include, for example, a MuleSoft system or an IBM App Connect Enterprise system.

The client integration tool 410 may include a flow editor component 411 as an interface used by an integration developer to view and construct integration flows. The flow editor component 411 interacts with any configured delegation integration modules 421-423 for required endpoint system types to construct directly the required components in the endpoint systems 441-443. The flow editor component 411 also uses the delegation integration modules 421-423 to examine the endpoint systems 441-443 to construct logical integration flows based on annotations or labels stored in these endpoint systems 441-443.

The delegation integration modules 421-423 running in the client integration tool 410 are created for each type of endpoint system 441-443 that can be part of an integration. A delegation integration module 421-423 needs to be created for each such endpoint system. In the simplest case, the endpoint systems will be true endpoint systems like an enterprise resource planning system or a customer relationship management system but may be any system that part of an integration could be configured in. This might include actual integration products like Mulesoft or IBM ACE to allow them to be part of an integration flow but these are not needed for the method to work. The endpoint systems 441-443 may provide injected integration modules 451, 453 at the endpoint systems 441, 443 providing additional code and configuration injected to enable connection with a delegation integration module 421, 423 and to run parts of the integration flow. The injected integration modules 451, 453 are optional as it may be possible to set up the connection purely using external interfaces 452 of the endpoint system as shown in type B endpoint system 442.

The delegation integration modules 421-423 for types of endpoint systems 441-443 may ensure that the following functionality is provided at the endpoint systems 441-443.

The delegation integration modules 421-423 may understand how to construct various artifacts in the endpoint system 441-443. The delegation integration modules 421-423 may require a scheme for storing metadata in that endpoint system 441-443 to show which components configured there are part of which logical integration flow.

The delegation integration modules 421-423 may understand what is and is not possible from within an endpoint system 441-443; in other words, the integration flow capabilities of the endpoint system 441-443. For example: the delegation integration module 421 would need to understand if the enterprise resource planning system has the function to call the customer relationship management system directly and hence a flow to integrate the two may be carried out just using the enterprise resource planning system and the customer relationship management system modules.

The delegation integration modules 421-423 may understand which instance of other endpoint systems are integrated in the artifacts the endpoint system owns. For example, if the enterprise resource planning system has an integration to call a specific customer relationship management system service instance, it needs to provide the customer relationship management system service instance identifier so that the identifier can be used to discover and chain other integrations in that specific customer relationship management system instance.

The delegation integration modules 421-423 include flow components 431, 433, 435 for interacting with the flow editor component 411 to build and run integration flows by delegating the flow functions to the endpoint systems 441-443.

The client integration tool 410 may include a flow monitor component 412 configured to allow the user to view monitoring information derived from the endpoint systems 441-443. The flow monitor component 412 follows a similar arrangement to the flow editor component 411 in its interaction with the endpoint systems 441-443. The flow monitor component 412 uses the delegation integration modules 421-423 to query the endpoint systems' 441-443 logs and monitoring mechanisms to build up an aggregated picture of how the integrations flow is working. It relies on the logging and monitoring data from endpoint systems 441-443 and does not require any central logging or monitoring solution.

The delegation integration modules 421-423 include monitoring components 432, 434, 436 for interacting with the flow monitor component 412 to monitor integration flows by using the monitoring to the endpoint systems 441-443.

Using the example of endpoint systems of an enterprise resource planning system and a customer relationship management system, an integration flow may be constructed as follows.

An integration developer may start up the client integration tool 410 providing configuration that defines how the delegation integration modules 421-423 should connect to the various endpoint systems. This configuration may be as simple as a configuration file.

In the case when there are no flows to start with, the client integration tool provides the flow editor component 411 which can then be used to start constructing an integration flow where any parts constructed are stored directly in the endpoint system.

For example, the user would select a trigger for data in the enterprise resource planning system. This would cause the flow editor component 411 to ask the enterprise resource planning system module to construct the trigger in the enterprise resource planning system and add metadata to signal it was the start of an integration flow.

The user may then select to do an update in the customer relationship management system based on that trigger. The enterprise resource planning system module would report to the flow editor component 411 that it could construct what was required in the enterprise resource planning system to call the customer relationship management system.

The flow editor component 411 may then ask the enterprise resource planning system module to set up this part of the integration. The customer relationship management system module may then be queried to see if it needs to expose anything for this call to occur and to also provide a trigger to do more actions in the customer relationship management system. In the simplest case, all the function for the flow could be provided in the enterprise resource planning system but as the flow gets more complex and required more systems, then more modules may be involved.

As another example, an integration flow may be created in the flow editor component 411 that is triggered by a new customer in the customer relationship management system and needs to create a customer in enterprise resource planning system.

The customer relationship management system has an artifact injected that is triggered on a new customer and then makes a REST call to the enterprise resource planning system. The artifact has metadata added to say it is for the given integration flow and that it starts the flow and then calls the enterprise resource planning.

The enterprise resource planning system has an artifact injected that allow REST calls in from the customer relationship management system and then makes a new customer. The artifact has metadata added to say it is for the given integration flow and that it is triggered from the customer relationship management system.

Modules for general purpose integration systems, like MuleSoft and IBM ACE, may also be involved for cases where the endpoint systems do not have the required functionality.

For existing integration flows, the client integration tool 410 starts up and queries each one of the involved delegation integration modules 421-423 asking them to query the end systems they understand and from that build up a set of integration flows based on this data. Each module 421-423 has added the correct metadata in the endpoint system when an integration flow was created so it can tell what flow it is part of and where in the flow it is being used.

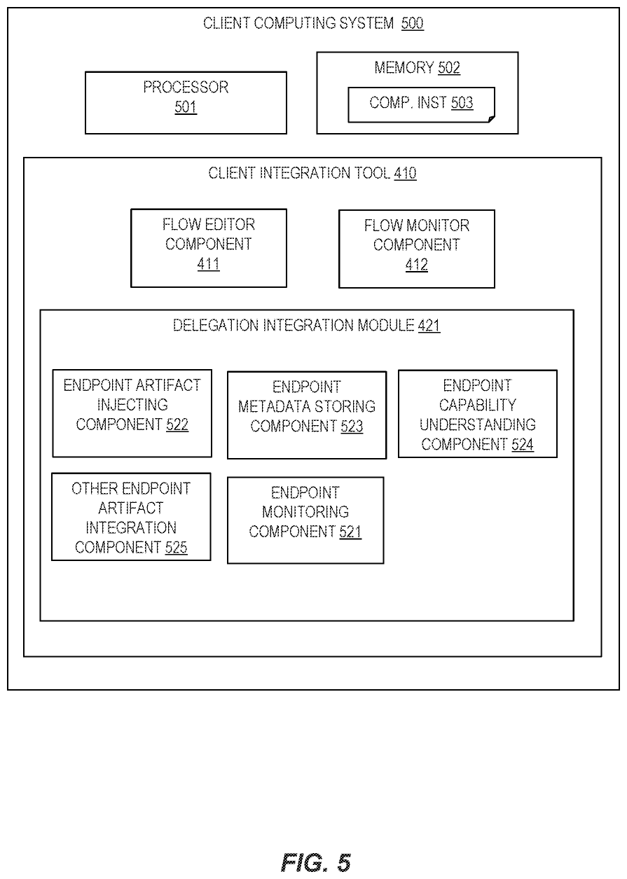

Referring to FIG. 5, a block diagram shows a client computing system 500 at which the client integration tool 410 may be provided. The client computing system 500 may include at least one processor 501, a hardware module, or a circuit for executing the functions of the described components which may be software units executing on the at least one processor. Multiple processors running parallel processing threads may be provided enabling parallel processing of some or all of the functions of the components. Memory 502 may be configured to provide computer instructions 503 to the at least one processor 501 to carry out the functionality of the components.

The client integration tool 410 may include the flow editor component 411 for constructing and editing integration flows that run using delegated functioning in the endpoint system. The flow editor component 411 may defining an integration flow with required endpoint systems and delegates integration tasks of the integration flow via delegation integration modules 421 to the required endpoint systems to use linked integration artifacts at the endpoint systems to carry out the tasks.

The client integration tool 410 may include a flow monitor component 412 for monitoring integration flows using gathered logs and metrics from the endpoint systems. The flow monitor component 412 may be configured to monitor an integration flow in involved endpoint systems using annotations in the linked integration artifacts with the annotations configured to gather and correlate logs and metrics from the involved endpoint systems. An endpoint monitoring component 521 may be provided as part of the delegation integration module 421.

The delegation integration modules 421 are provided for each of multiple disparate types of endpoint systems. A delegation integration module 421 for a type of endpoint system is configured to understand how to construct and coordinate integration artifacts in the endpoint system type. A delegation integration module 421 includes an endpoint artifact injecting component 522 for injecting or configuring code in an endpoint system for interaction with a delegation integration module for the endpoint system type at the client integration tool.

The delegation integration module 421 for a type of endpoint system includes an endpoint metadata storing component 523 for providing a scheme for storing metadata in that endpoint system type to show which components configured there are part of which logical integration flow.

The delegation integration module 421 for a type of endpoint system includes an endpoint capability understanding component 524 for understanding the capabilities of an endpoint system type.

The delegation integration module 421 for a type of endpoint system includes an other endpoint artifact integration component 525 for handling which instances of other endpoint systems are integrated in the artifacts the endpoint system owns.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

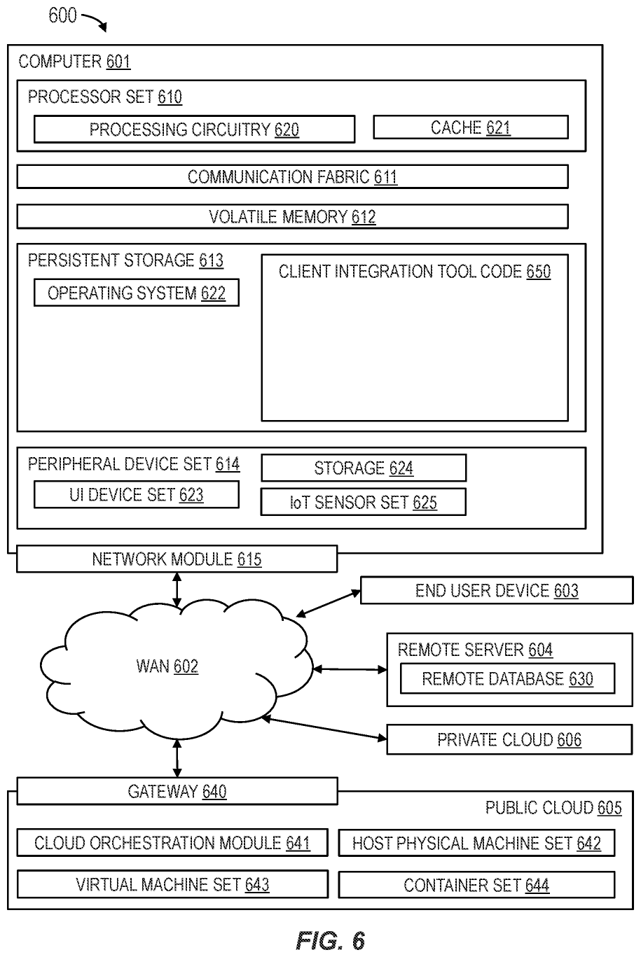

Referring to FIG. 6, computing environment 600 contains an example of an environment for the execution of at least some of the computer code involved in performing the inventive methods, such as client integration tool code 650. In addition to block 650, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 650, as identified above), peripheral device set 614 (including user interface (UI) device set 623, storage 624, and Internet of Things (IOT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 650 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 650 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Set of thing(s): does not include the null set; “set of thing(s)” means that there exist at least one of the thing, and possibly more; for example, a set of computer(s) means at least one computer and possibly more.

What is claimed is:

1. A computer-implemented method for running an integration flow between endpoint systems, the method comprising:
receiving an integration flow, wherein the integration flow includes a plurality of integration tasks, and endpoint systems required for the integration flow;
constructing, using a respective delegation integration module for each endpoint system required for the integration flow, a plurality of linked integration artifacts corresponding to the plurality of integration tasks of the integration flow, wherein each delegation integration module is configured to understand how to construct and coordinate integration artifacts in a particular type of endpoint system; and
delegating the plurality of integration tasks of the integration flow to the endpoint devices required for the integration flow, wherein the delegating includes injecting, using the respective delegation integration module for each endpoint system, the plurality of linked integration artifacts into the endpoint systems, and wherein the injected plurality of linked artifacts cause the endpoint systems to carry out the plurality of integration tasks of the integration flow without the use of an integration engine.

2. The method as claimed in claim 1 wherein the plurality of linked integration artifacts include annotations configured to gather and correlate logs and metrics from the endpoint systems involved in the integration flow.

3. The method as claimed in claim 2 further comprising:
gathering and correlating logs and metrics generated by the endpoint systems while running the integration flow using the annotations included in the plurality of linked artifacts.

4. The method of claim 3 further comprising:
injecting and configuring code in an endpoint system for interaction with a delegation integration module for the endpoint system at a client integration tool.

5. The method of claim 1 further comprising:
injecting and configuring code in an endpoint system for interaction with a delegation integration module for the endpoint system at a client integration tool.

6. The method of claim 1 wherein constructing, using a respective delegation integration module for each endpoint system required for the integration flow, a plurality of linked integration artifacts corresponding to the plurality of integration tasks of the integration flow further comprises:
discovering data objects from the endpoint systems required for the integration flow and associated modeling relationships between the endpoint systems using transformation logic and data mappings.

7. A computer program product (CPP) for running an integration flow between endpoint systems, the CPP comprising:
a set of storage device(s); and
computer code stored collectively in the set of storage device(s), with the computer code including data and instructions to cause a processor(s) set to perform at least the following operations:
receiving an integration flow, wherein the integration flow includes a plurality of integration tasks, and endpoint systems required for the integration flow;
constructing, using a respective delegation integration module for each endpoint system required for the integration flow, a plurality of linked integration artifacts corresponding to the plurality of integration tasks of the integration flow, wherein each delegation integration module is configured to understand how to construct and coordinate integration artifacts in a particular type of endpoint system; and
delegating the plurality of integration tasks of the integration flow to the endpoint devices required for the integration flow, wherein the delegating includes injecting, using the respective delegation integration module for each endpoint system, the plurality of linked integration artifacts into the endpoint systems, and wherein the injected plurality of linked artifacts cause the endpoint systems to carry out the plurality of integration tasks of the integration flow without the use of an integration engine.

8. The CPP as claimed in claim 7 wherein the plurality of linked integration artifacts include annotations configured to gather and correlate logs and metrics from the endpoint systems involved in the integration flow.

9. The CPP as claimed in claim 8 further comprising:
gathering and correlating logs and metrics generated by the endpoint systems while running the integration flow using the annotations included in the plurality of linked artifacts.

10. The CPP of claim 9 wherein the computer code further includes data and instructions for causing the processor(s) set to perform the following further operation(s):
injecting and configuring code in an endpoint system for interaction with a delegation integration module for the endpoint system at a client integration tool.

11. The CPP of claim 7 wherein the computer code further includes data and instructions for causing the processor(s) set to perform the following further operation(s):
injecting and configuring code in an endpoint system for interaction with a delegation integration module for the endpoint system at a client integration tool.

12. The CPP of claim 7 wherein constructing, using a respective delegation integration module for each endpoint system required for the integration flow, a plurality of linked integration artifacts corresponding to the plurality of integration tasks of the integration flow further comprises:
discovering data objects from the endpoint systems required for the integration flow and associated modeling relationships between the endpoint systems using transformation logic and data mappings.

13. A computer system (CS) for running an integration flow between endpoint systems, the CS comprising:
a processor(s) set;
a set of storage device(s); and
computer code stored collectively in the set of storage device(s), with the computer code including data and instructions to cause the processor(s) set to perform at least the following operations:
receiving an integration flow, wherein the integration flow includes a plurality of integration tasks, and endpoint systems required for the integration flow;
constructing, using a respective delegation integration module for each endpoint system required for the integration flow, a plurality of linked integration artifacts corresponding to the plurality of integration tasks of the integration flow, wherein each delegation integration module is configured to understand how to construct and coordinate integration artifacts in a particular type of endpoint system; and
delegating the plurality of integration tasks of the integration flow to the endpoint devices required for the integration flow, wherein the delegating includes injecting, using the respective delegation integration module for each endpoint system, the plurality of linked integration artifacts into the endpoint systems, and wherein the injected plurality of linked artifacts cause the endpoint systems to carry out the plurality of integration tasks of the integration flow without the use of an integration engine.

14. The CS as claimed in claim 13 further comprising:
gathering and correlating logs and metrics generated by the endpoint systems while running the integration flow using the annotations included in the plurality of linked artifacts.

15. The CS as claimed in claim 14 w further comprising:
gathering and correlating logs and metrics generated by the endpoint systems while running the integration flow using the annotations included in the plurality of linked artifacts.

16. The CS of claim 15 wherein the computer code further includes data and instructions for causing the processor(s) set to perform the following further operation(s):
injecting and configuring code in an endpoint system for interaction with a delegation integration module for the endpoint system at a client integration tool.

17. The CS of claim 13 wherein the computer code further includes data and instructions for causing the processor(s) set to perform the following further operation(s):
injecting and configuring code in an endpoint system for interaction with a delegation integration module for the endpoint system at a client integration tool.

18. The CS of claim 13 wherein constructing, using a respective delegation integration module for each endpoint system required for the integration flow, a plurality of linked integration artifacts corresponding to the plurality of integration tasks of the integration flow further comprises:
discovering data objects from the endpoint systems required for the integration flow and associated modeling relationships between the endpoint systems using transformation logic and data mappings.
